(19) United States
(12) Patent Application Publication
(10) Pub. No.: US 2026/0243219 A1
(43) Pub. Date: Aug. 20, 2026

(54) EXHAUST GAS RECIRCULATION CIRCUIT FOR IMPROVED PARTICLE FILTER REGENERATION

(71) Applicant: Volvo Truck Corporation, GÖTEBORG (SE)

(72) Inventors: Anders Mohlin, Kungsbacka (SE); Christian Dansund, Göteborg (SE); Erik Ewerlöf, Landvetter (SE); Daniel Bernhardsson, Göteborg (SE); David Moldin, Mölndal (SE); Richard Senften, Kode (SE)

(21) Appl. No.: 19/532,841

(22) Filed: Feb. 6, 2026

(30) Foreign Application Priority Data
Feb. 19, 2025 (EP) 25158874

(51) Int. Cl. F02M 26/16; F02M 26/22; F02M 26/39; F02M 26/53; F02M 26/65

(52) U.S. Cl. CPC F02M 26/16; F02M 26/22; F02M 26/39; F02M 26/53; F02M 26/65

(57) ABSTRACT

An EGR circuit of an internal combustion engine including an inlet and exhaust manifold for collecting exhaust gas is disclosed. The EGR circuit is configured to evolve between a flowing configuration, in which exhaust gas is allowed to flow through it, and a closed configuration, in which the exhaust gas flow through it is prevented. The EGR circuit comprises an EGR mixer fluidically connected to the inlet manifold, and configured to mix exhaust gas and air, an EGR cooler; an exhaust pipe fluidically connecting the exhaust manifold to the EGR cooler; an intermediate pipe fluidically connecting the EGR cooler to the EGR mixer; and a first EGR valve mounted in the exhaust pipe, to adjust and/or prevent the exhaust gas flow.

### CROSS REFERENCE TO RELATED APPLICATION

This application claims foreign priority to European Application 25158874.5, filed on February 19, 2025, the disclosure and content of which is incorporated by reference herein in its entirety.

### TECHNICAL FIELD

The disclosure relates generally to exhaust gas recirculation circuit for an engine, for example, but not limited to, of a vehicle. It concerns an exhaust gas recirculation circuit that can both reduce NOx emissions of the internal combustion engine (ICE) of the vehicle while enabling regeneration of the particle filter (PF) when required by faciliating either a sufficient exhaust gas recirculation (EGR) flow rate into the inlet manifold of the ICE for NOx emissions reduction or temporarily stopping the EGR flow rate for particle filter regeneration. In particular aspects, the disclosure relates to an exhaust gas recirculation circuit for improved particle filter regeneration. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

During the combustion process inside cylinders of an internal combustion engine (ICE), fuel and air are injected into the cylinders of the ICE and the combustion operating inside the cylinders enables production of mechanical power intended to be transmitted, via a transmission line, from the output shaft of the ICE to the wheels to enable the vehicle propulsion. The combustion involves the chemical reaction inside the cylinder of fuel and dioxygen from the air, thereby forming main products such as water and carbon dioxide as well as unwanted pollutants such as soot and nitrogen oxides (NOx) emissions.

NOx are formed during the combustion process due to the presence of nitrogen in the air. Indeed, when high temperatures in the order of 1300 °C are reached, which is the case inside the cylinder, the nitrogen in the air recombines with the dioxygen to form chemical species such as NO and NO2, gathered under the denomination NOx emissions.

Soot is a carbon-rich aggregate that is formed when partial combustion occurs. Fuel for ICE is typically composed of a large variety of hydrocarbons, many of them presenting a long carbon chain. As combustion is rarely totally complete, these long carbon chains recombine with each other according to a complex reaction scheme. It results in the formation of soot.

Emission standards have been introduced to limit the emission of pollutants into the atmosphere. In Europe, the emission standard is called Euro legislations. The disclosed technology aims at complying with the European emission requirement EU7, as well as the US requirements EPA27 and CARB27. These standards set maximum pollutant emission limits for new vehicles. There are several standards, depending on the type of vehicle. The standards evolve over time and become progressively stricter. Their aim is to reduce air pollution from road transport.

In order to reduce emissions of ICE, several measures are already taken and systems were developed in the past to limit soot and NOx emissions.

On the one hand, in order to reduce NOx emissions, cooled exhaust gas recirculation (EGR) circuits were introduced. Exhaust gas recirculation (EGR) is based on the redirection of a part of the exhaust gases from the exhaust manifold of the internal combustion engine through a liquid cooled EGR cooler into the intake manifold (e.g., the inlet manifold) to reduce NOx emissions. This redirection of exhaust gases leads to a reduction of the combustion temperature inside the cylinder as the oxygen part is reduced. The EGR flow rate is controlled by an EGR valve controlled by a control unit of the ICE depending on the load and speed of the ICE. Thanks to the EGR, a reduction of NOx formation is achieved. Nevertheless, the EGR generally implies soot formation as this recirculation results in the reduction of the air to fuel ratio.

On the other hand, particle filter, be it Diesel particle filter or Gasoline particle filter depending on the type of the ICE, were added to the Exhaust Aftertreatment System to limit soot emissions. Such a particle filter is typically mounted on the exhaust line of the engine, downstream of the turbine outlet, and catches the soot particles coming out of the exhaust manifold and directed towards the exhaust line, thanks to its honeycomb structure. From time to time, when the particle filter is loaded with soot particles at a predefined level, it is necessary to trigger the particle filter regeneration during which the soot particles are burnt in its internal ceramic thanks to the heat generated by the exhaust line.

It is to be noted that as the exhaust gas temperature from a gasoline ICE rises more quickly than that of a Diesel ICE, the Gasoline particle filter generally does not need to be voluntarily regenerated in order to clean up. Indeed soot particles are processed more easily, continuously and almost in real time. For example, when decelerating or under full load, the gasoline particle filter cleans itself without the driver noticing.

However, the principle of the disclosed technology that will be described below may be applied within the framework of an Exhaust Aftertreatment System of any ICE that may produce soot and NOx.

In order to control the EGR flow rate to meet a target value of EGR flow rate in the line from the exhaust manifold to the inlet manifold of the ICE, a cooled EGR valve is placed in between. The cooled EGR valve is intended to redirect a part, for example, but not limited to, 10 to 20%, of the exhaust gas from the exhaust manifold to the inlet manifold. When the cooled EGR valve is fully open, this part of the exhaust gas passes through the line from the exhaust manifold to the inlet manifold. When the cooled EGR valve is fully closed, no exhaust gas passes through the line. Having the cooled EGR valve in a position between fully open and fully closed enables to control the EGR flow rate in the line. In the prior art, this cooled EGR valve is mounted in the line between the exhaust manifold and the inlet manifold at a sufficient distance from the exhaust manifold. It means that the cooled EGR valve is typically mounted nearer to the inlet manifold than the exhaust manifold. This position ensures that the cooled EGR valve is exposed to exhaust gases having a lower temperature than the one they have in the vicinity of the exhaust manifold, thereby preventing the valve plate of the cooled EGR valve, which is actuated inside the housing of the cooled EGR valve to control the exhaust gas flow rate, to stick to the housing of the cooled EGR valve.

When triggering the particle filter regeneration, it is necessary to operate the ICE with a fully closed EGR valve. Indeed, in order to be able to burn the soot particles during the particle filter regeneration, the ICE may provide to the Exhaust Aftertreatment System (EATS) line exhaust gases fulfilling the conditions of a high enough exhaust gas temperature, mass flow rate and NOx emissions simultaneously. If any one of these parameters is below a threshold value, the particle filter regeneration can either not be performed at all or can be performed with significantly increased duration (e.g., several hours engine running time), which is not acceptable.

Therefore, during the particle filter regeneration, the EGR flow rate is set to zero, which means that the cooled EGR valve should be fully closed. In reality, even when cooled EGR valve is in its fully closed position, there is still an EGR flow rate passing through it. This is due to the fact that there is a clearance, inside the housing of the cooled EGR valve, between the valve plate and the housing, in order to avoid a sticking of the valve plate to the housing as exhaust gas with a high temperature flow through this valve. It leads to an EGR internal leakage flow through the EGR cooled valve even when it is desired to have it in its fully closed position.

There exists single or dual poppet EGR valves known to have less internal leakage compared to commonly used single butterfly EGR valves. Unfortunately, such valves have the disadvantages of leading to high pressure drops and requiring high control forces. Additionally, in a position corresponding to a small opening of the EGR valve, a single or dual poppet valve is more difficult to control compared to a single butterfly valve.

The disclosed technology falls within this context and proposes an EGR circuit allowing particle filter regeneration by providing the required conditions in terms of exhaust gas temperature, flow rate and NOx content.

Another aspect of the disclosed technology is to achieve a reduction of the EGR internal leakage when the cooled EGR valve is fully closed, thereby increasing the NOx contents to a level above the minimum threshold.

### SUMMARY

According to a first aspect of the disclosure, an exhaust gas recirculation circuit of an internal combustion engine comprises an inlet manifold and an exhaust manifold for collecting exhaust gas from the combustion in the internal combustion engine, said exhaust gas recirculation circuit being configured to evolve between a flowing configuration, in which exhaust gas is allowed to flow through it, and a closed configuration, in which the exhaust gas flow through it is prevented, and vice versa, said exhaust gas recirculation circuit comprising:

An EGR mixer intended to be fluidically connected to the inlet manifold, and configured to be supplied with exhaust gas and air, and to mix them,

An EGR cooler intended to be supplied with exhaust gas at an exhaust temperature from the exhaust manifold and to deliver exhaust gas at a target inlet temperature,

An exhaust pipe intended to fluidically connect the exhaust manifold to the EGR cooler,

An intermediate pipe fluidically connecting the EGR cooler to the EGR mixer,

A first EGR valve configured to adjust the exhaust gas flow rate flowing from the exhaust manifold to the EGR mixer in the flowing configuration and to prevent the - exhaust gas flow to the EGR mixer in the closed configuration, said first EGR valve being mounted in the exhaust pipe.

Thanks to these features, the exhaust gas recirculation circuit of the disclosed technology offers a more reactive response of the internal combustion engine in transient phases when it changes its running mode. Such a transient phase is the switching from a phase when the internal combustion engine is running and exhaust gas recirculation is operating to a phase when the stop, or at least a significant reduction, of the exhaust gas recirculation is required to elevate the exhaust gas temperature, mass flow rate and NOx content towards the exhaust aftertreatment system. The particular positioning of the first EGR valve upstream of the EGR cooler reduces the dead volume to the exhaust manifold volume. It means that the volume possibly occupied by the exhaust gas in the exhaust pipe is reduced to a minimum. It results in an upgrade of the response of the internal combustion engine to the above-mentioned switching.

Optionally in some examples, including in at least one preferred example, the first EGR valve is mounted on the exhaust manifold. The first EGR valve forms a port directly on a wall of the exhaust manifold to direct exhaust gas into the exhaust pipe towards the EGR cooler if required. Such a positioning offers the advantage of no dead volume in the exhaust pipe, thereby avoiding negative impact on the transient response of the internal combustion engine.

Optionally in some examples, including in at least one preferred example, the exhaust gas recirculation circuit comprises a second EGR valve mounted in the intermediate pipe, said second EGR valve being configured to switch from an open position to a shut-off position to prevent exhaust gas flow from the exhaust manifold to the EGR mixer in the closed configuration.

Optionally in some examples, including in at least one preferred example, the first EGR valve is a butterfly valve.

Optionally in some examples, including in at least one preferred example, the second EGR valve is a butterfly valve.

A butterfly valve has the advantage of not leading to high pressure drops compared to a poppet valve. Furthermore, a butterfly valve is easier to control, as it does not require a high control force to be actuated.

The second EGR valve is positioned downstream of the EGR cooler. When the exhaust gas recirculation circuit is in the flowing position, it means that exhaust gas recirculation from the exhaust manifold to the inlet manifold is allowed. The first EGR valve is open and the second EGR valve is in its open position. The exhaust gas flow rate is controlled by the percentage of aperture of the first EGR valve and the second EGR valve. It is to be noted that the second EGR valve may be either in its open position, e.g., fully open, or in its shut-off position, e.g., fully closed, without any other intermediate position, or it may evolve between its open and shut-off position under a plurality of other percentages of aperture, thereby also controlling the exhaust gas flow rate. In case the second EGR valve takes only an open or closed position, the exhaust gas flow rate is controlled by the first EGR valve.

As the first EGR valve is mounted upstream of the EGR cooler, between the exhaust manifold and the EGR cooler, and possibly on the exhaust manifold, it implies that the first EGR valve is exposed to exhaust gas having a high temperature. In order to avoid a malfunction of the first EGR valve that could occur due to these high temperatures, a clearance between the valve housing and the valve plate is necessary. This clearance avoids the sticking of the valve plate to the valve housing. This also implies that in a fully closed position of the first EGR valve, a low exhaust gas flow rate is allowed to flow through the first EGR valve. In most of the running conditions of the internal combustion engine, this has no impact as the main parameters of exhaust gas temperature, flow rate and NOx content do not go below the threshold limits to enable a particle filter regeneration. But in some other running conditions, especially at low loads of the internal combustion engine, NOx content, and thus exhaust gas temperature, should be increased to reach the required threshold limits. The low exhaust gas flow rate through the first EGR valve, also called internal leakage, may lead to the difficulty, or even impossibility, to obtain the required conditions for particle filter regeneration.

The second EGR valve overcomes this problem as it is able to turn into its shut-off valve when the exhaust gas recirculation circuit should be placed in its closed configuration. As the second EGR valve is positioned downstream of the EGR cooler, it is exposed to lower exhaust gas temperature. Therefore, the risk of sticking its valve plate to the valve housing is significantly reduced compared to the first EGR valve. It follows that the second EGR valve may be designed to present a very small clearance between the valve plate and the valve housing. From this design, it results that in its shut-off position, almost no exhaust gas can flow through the second EGR valve.

The second EGR valve makes it possible to decrease, or even avoid, the EGR leak flow with the exhaust gas recirculation circuit. It enables an increase in the NOx content in the exhaust gas to a level above the threshold limit required in the exhaust line for operating the particle filter regeneration.

The positioning of the second EGR valve downstream of the EGR cooler leads to two technical properties for the second EGR valve: on the one hand, and as explained above, the second EGR valve faces exhaust gas with a lower temperature (in comparison to a positioning upstream of the EGR cooler), thereby making it possible to use a second EGR valve with a small clearance between the valve plate and the valve housing. On the other hand, the volume flow downstream of the EGR cooler is lower than the EGR flow upstream of the EGR cooler. It results in an intermediate pipe of a smaller diameter than the diameter of the exhaust pipe (e.g., the pipe upstream of the EGR cooler), and also a second EGR valve with a small diameter. These properties have the synergetic effect of significantly reducing the EGR leak flow.

Optionally in some examples, including in at least one preferred example, the exhaust gas recirculation circuit further comprises an actuator connected to the second EGR valve, said actuator being configured to actuate the second EGR valve into its shut-off position when the exhaust gas recirculation circuit evolves from the flowing configuration to the closed configuration.

Each of the first EGR valve and the second EGR valve is associated with an actuator. As it will be detailed below, the internal combustion engine comprises a control unit configured to control various parameters of the internal combustion engine. Namely the control unit is configured to receive signals indicative of the state of the internal combustion engine and send commands to at least the actuators of the EGR valves to make the internal combustion engine operate according to instructions that may be stored on the control unit or on a remote memory and in communication with the control unit.

Optionally in some examples, including in at least one preferred example, the actuator is a pneumatic actuator.

Optionally in some examples, including in at least one preferred example, the actuator is an electric actuator.

According to a second aspect of the disclosure, an internal combustion engine comprises an inlet manifold, an exhaust manifold for collecting exhaust gas from the combustion in the internal combustion engine, and an exhaust system comprising:

an exhaust gas recirculation circuit as described in this document,

an exhaust aftertreatment system intended to process pollutants contained in the exhaust gas,

an exhaust line fluidically connecting the exhaust manifold to the exhaust aftertreatment system,

a control unit configured to send a switching signal to the exhaust gas recirculation circuit to evolve from the flowing configuration to the closed configuration, and vice versa.

Optionally in some examples, including in at least one preferred example, the internal combustion engine further comprises a throttle mounted in the exhaust line and a throttle actuator connected to the throttle and configured to actuate the throttle, so as to maintain a target value of the pressure inside the exhaust manifold.

The control of the throttle facilitates reaching the target pressure inside the exhaust manifold, so that the internal combustion engine might operate as required. The actuation of the throttle is required when the threshold limits for launching the particle filter regeneration are not achieved. Further to the actuation of the throttle leading to a temporary at least partly stop of the exhaust gas flowing in the exhaust line, the temperature of the exhaust gas increases and NOx content is above the threshold limit. Together with the evolving of the exhaust gas recirculation circuit from its flowing configuration to its closed configuration, it allows the particle filter regeneration to occur.

Optionally in some examples, including in at least one preferred example, the throttle actuator is an electric actuator.

Optionally in some examples, including in at least one preferred example, the internal combustion engine further comprises a compressed air unit and a main air supply pipe fluidically connecting the compressed air unit to the throttle actuator, said throttle actuator being a pneumatically driven actuator, said compressed air unit being configured to provide compressed air to the throttle actuator.

Optionally in some examples, including in at least one preferred example, the internal combustion engine further comprises an auxiliary air supply pipe fluidically connecting the main air supply pipe to the pneumatic actuator, said pneumatic actuator and the throttle actuator being configured to be simultaneously supplied with compressed air.

With actuators being of pneumatic type, it is possible to share the compressed air unit capacity to dispatch compressed air where needed in the exhaust gas recirculation circuit. It results in an efficient operating of the internal combustion engine.

Optionally in some examples, including in at least one preferred example, the pneumatic actuator is connected to the exhaust manifold.

The internal combustion engine according to the disclosed technology as described above further exhibits advantages similar to those of the exhaust gas recirculation circuit according to the disclosed technology. Other technical effects and advantages will be detailed in the description of the figures.

According to a third aspect of the disclosure, a vehicle comprises such an internal combustion engine.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a perspective view of an exemplary vehicle equipped with an internal combustion engine and an exhaust gas recirculation circuit according to an example.

FIG. 2 is a schematic diagram showing an exemplary exhaust gas recirculation circuit according to an example.

FIG. 3 is a schematic diagram showing an exemplary exhaust gas recirculation circuit according to an example.

FIG. 4 is a schematic diagram showing an exemplary exhaust gas recirculation circuit according to an example.

FIG. 5 is a schematic diagram showing an exemplary exhaust gas recirculation circuit according to an example.

### DETAILED DESCRIPTION

The detailed description set forth below provides information and examples of the disclosed technology with sufficient detail to enable those skilled in the art to practice the disclosure.

The characteristics, variants and various embodiments of the disclosed technology, as they have been described or as they will be presented in the detailed description which follows, can be associated with each other, according to various combinations, to the extent that they are not incompatible or exclusive with respect to each other. In particular, it will be possible to imagine variants of the disclosed technology comprising only a selection of characteristics described subsequently isolated from the other characteristics described, if this selection of characteristics is sufficient to confer a technical advantage and/or to differentiate the disclosed technology compared to the prior art.

For the sake of clarity, the same elements are designated by the same references in the different figures.

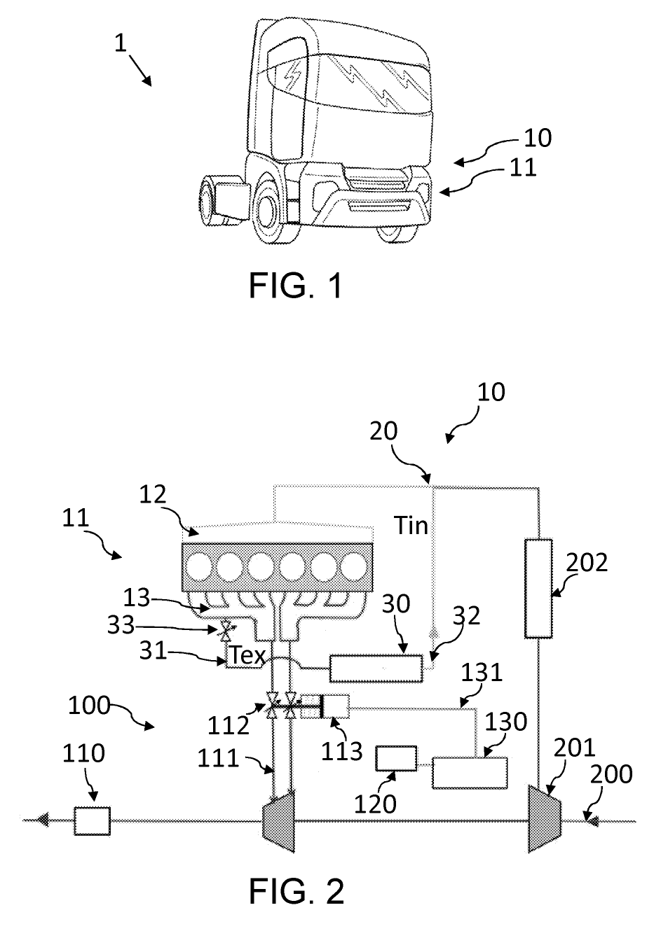

FIG. 1 is a perspective view of an exemplary of a vehicle equipped with an internal combustion engine 11 and an exhaust gas recirculation circuit 10 according to an example. As illustrated, vehicle 1 is a truck. Nevertheless, the method according to the disclosed technology may be applied to any internal combustion engine and exhaust gas recirculation circuit, and the vehicle may be any vehicle, for example a bus or a car.

FIG. 2 a schematic diagram showing an exemplary exhaust gas recirculation circuit 10 according to an example. In FIG. 2, an internal combustion engine 11 is schematically represented. The internal combustion engine 11 comprises a plurality of cylinders. As an example, the internal combustion engine is a 6-cylinder in line engine. This arrangement is an example of an engine to which the disclosed technology can be applied. But the scope of the disclosed technology is not limited to this kind of engine and can be applied to any other type of internal combustion engine, whatever the number of cylinders and their disposition in relation to each other are.

The internal combustion engine 11 comprises an inlet manifold 12 and an exhaust manifold 13. The inlet manifold is configured to receive air to be provided to the cylinders of the internal combustion engine 11. When operating, the internal combustion engine 11 receives air from the inlet manifold 12, fuel is injected into the cylinders. Combustion occurs inside the cylinders, thereby enabling to produce mechanical power intended to be transmitted, via a transmission line, from the output shaft of the internal combustion engine to the wheels to enable the vehicle propulsion. The combustion involves the chemical reaction inside the cylinder of fuel and dioxygen from the air, thereby forming main products such as water and carbon dioxide as well as unwanted pollutants such as soot and nitrogen oxides (NOx) emissions.

The exhaust manifold 13 collects the exhaust gas from the combustion inside the cylinders of the internal combustion engine 11.

The internal combustion engine 11 also comprises an exhaust system 100 comprising an exhaust gas recirculation circuit 10 that will be described in detail below. The exhaust system 100 further comprises an exhaust aftertreatment system 110 intended to process pollutants contained in the exhaust gas, an exhaust line 111 fluidically connecting the exhaust manifold 13 to the exhaust aftertreatment system 110, and a control unit 120 configured to send signals to the exhaust gas recirculation circuit 10 depending on the operation of the internal combustion engine 11.

The exhaust aftertreatment system 110 will not be described in detail as it comprises aftertreatment elements known in the prior art, such as a particle filter to physically catch the soot particles emitted by the internal combustion engine 11 during phases of the combustion process wherein the combustion is not taking place as a complete combustion, and eventually a SCR system (selective catalyst reduction) to transform remaining NOx in the exhaust gas flowing in the exhaust line 111 into N2 and H2O.

The exhaust gas recirculation circuit 10 of the disclosed technology will now be described in detail. The exhaust gas recirculation circuit 10 is configured to evolve between a flowing configuration, in which exhaust gas is allowed to flow through it, and a closed configuration, in which the exhaust gas flow through it is prevented, and vice versa. In other words, in the flowing configuration, exhaust gas can flow through the exhaust gas recirculation circuit 10, and in the closed configuration, exhaust gas cannot flow through the exhaust gas recirculation circuit 10. The exhaust gas recirculation circuit 10 may switch from the flowing configuration to the closed configuration and it may also switch from the closed configuration to the flowing configuration.

The exhaust gas recirculation circuit 10 comprises an EGR mixer 20 intended to be fluidically connected to the inlet manifold 12, and configured to be supplied with exhaust gas and air, and to mix them. The internal combustion engine 11 comprises an air inlet 200 to provide air to the cylinders. The air from the air inlet goes through a compressor 201 before entering a charge air cooler 202. The outlet of the charge air cooler 202 is fluidically connected to the EGR mixer 20. This constitutes the air providing line.

The exhaust gas recirculation circuit 10 comprises an EGR cooler 30, intended to be supplied with exhaust gas at an exhaust temperature Tex from the exhaust manifold 13 and to deliver exhaust gas at a target inlet temperature Tin. In other words, the role of the EGR cooler 30 is to reduced the temperature of the exhaust gas from Tex down to Tin. The exhaust gas recirculation circuit 10 comprises an intermediate pipe 32 fluidically connecting the EGR cooler 30 to the EGR mixer 20. It is to be understood that the intermediate pipe 32 extends from an outlet of the EGR cooler 30 to an inlet of the EGR mixer 20. It results that the exhaust gas flowing through the EGR cooler 30 mixes with the air flowing through the air providing line in the EGR mixer 20, to form a mixture of air and exhaust gas. The EGR mixer 20 may have any form that enables the mixture of air and exhaust gas. It may be a simple pipe to which the intermediate pipe 32 and the air providing line are fluidically connected, or it may be a mixer having a dedicated volume to enable air and exhaust gas to mix before entering the pipe fluidically connected to the inlet manifold 12.

The exhaust gas recirculation circuit 10 comprises an exhaust pipe 31 intended to fluidically connect the exhaust manifold 13 to the EGR cooler 30. Following what was described above, it appears clear that exhaust gas is produced during combustion and are collected in the exhaust manifold 13. Their temperature is Tex. The main part of the exhaust gas flows towards the exhaust line 111, they usually pass through a turbine to reach the exhaust aftertreatment system 110 where they are treated in order to remove NOx and soot. A part of the exhaust gas in the exhaust manifold 13 is directed through the exhaust gas recirculation circuit 10. This part of the exhaust gas flows through the exhaust pipe 31 to enter the EGR cooler 30 where the temperature of the exhaust gas decreases from Tex to Tin. The exhaust gas leaves the EGR cooler and flows through the intermediate pipe 32 toward the EGR mixer 20, where it is mixed with fresh air coming from the air inlet. The mixture of fresh air and exhaust gas is directed to the inlet manifold 12. The part of the exhaust gas that recirculates towards the inlet manifold is therefore cooled in the EGR cooler 30, for example a liquid cooled EGR cooler. The recirculation of the cooled exhaust gas results in the reduction of the ratio of dioxygen entering the cylinders, thereby leading to lower combustion temperatures. The level of NOx emitted during the combustion is lower.

In order to enable the recirculation of a part of the exhaust gas, the exhaust gas recirculation circuit 10 comprises a first EGR valve 33 configured to adjust the exhaust gas flow rate flowing from the exhaust manifold 13 to the EGR mixer 20 in the flowing configuration and to prevent the exhaust gas flow to the EGR mixer 20 in the closed configuration.

According to the disclosed technology, the first EGR valve 33 is mounted in the exhaust pipe 31. In the flowing direction of the exhaust gas from the exhaust manifold to the inlet manifold, the first EGR valve 33 is mounted upstream of the EGR cooler 30.

The EGR flow rate is therefore controlled by the first EGR valve controlled by a control unit of the internal combustion engine depending on the load and speed of the internal combustion engine. As explained before, the recirculation of a part of the exhaust gas makes it possible to achieve a reduction of NOx formation.

The opening of the first EGR valve 33 determines the EGR flow rate through the exhaust gas recirculation circuit 10. For this purpose, the first EGR valve 33 can be fully open, meaning that a maximal flow rate of exhaust gas recirculated through the exhaust gas recirculation circuit 10. The first EGR valve 33 can be partly open. In this configuration, the percentage of its opening determines a lower EGR flow rate. The percentage of the opening of the first EGR valve 33 is mainly driven by the load of the internal combustion engine and the NOx level in the exhaust manifold 13. As an example, the maximal percentage of exhaust gas measured in the inlet manifold is about 15%.

Positioning the first EGR valve 33 upstream of the EGR cooler 30 means that the EGR first EGR valve 33 is mounted in the vicinity of the exhaust manifold, where the exhaust gas are the hottest. This positioning is counterintuitive as it is preferred to place it downstream of the EGR cooler, so that it is exposed to cooled exhaust gas.

In comparison to a positioning downstream of the EGR cooler, this particular positioning of the first EGR valve 33 upstream of the EGR cooler reduces the dead volume to the exhaust manifold volume. Such a dead volume has a negative impact on the transient response of the internal combustion engine. It results that the disclosed technology upgrades the response of the internal combustion engine in terms of rapidity.

Optionally in some examples, including in at least one preferred example, the first EGR valve 33 is mounted directly on the exhaust manifold 13. It means that the first EGR valve 33 forms an outlet port of the exhaust manifold 13. When the first EGR valve 33 opens, at least partly, exhaust gas can flow through it, resulting in exhaust gas flowing through the exhaust gas recirculation circuit 10. As such, there is no dead volume to the exhaust manifold volume.

As depicted in FIG. 2, the internal combustion engine 11 further comprises a throttle 112 mounted in the exhaust line 111. As a reminder, the exhaust line 111 is a line fluidically connected to the exhaust manifold 13 on the one side and to the exhaust aftertreatment system 110 on the other side. The exhaust line 111 is therefore the line in which exhaust gas flows out of the exhaust manifold to the aftertreatment system.

The internal combustion engine 11 further comprises a throttle actuator 113 connected to the throttle 112. The throttle actuator is configured to actuate the throttle 112. The throttle 112 may take various positions. Depending on the positions taken of the throttle 112, it results in a corresponding pressure value in the exhaust manifold 13. The actuation of the throttle 112 allows to maintain a target value of the pressure inside the exhaust manifold 13.

As a non-limitative example, the throttle actuator 113 may be an electric actuator.

As another example, the throttle actuator 113 may be a pneumatically driven actuator. In this case, the internal combustion engine 11 further comprises a compressed air unit 130 and a main air supply pipe 131 fluidically connecting the compressed air unit 130 to the throttle actuator 113. The compressed air unit 130 is configured to provide compressed air to the throttle actuator 113. As depicted in FIG. 2, the control unit 120 is operatively connected to the compressed air unit 130. It means that the control unit 120 send commands to the compressed air unit 130 to operate according to instructions that may be stored in the control unit. Depending on the level of pressure inside the exhaust manifold 13, the control unit 120 triggers the compressed air unit 130 to provide compressed air to the throttle actuator 113 to activate the throttle 112.

As it is not the core of the disclosed technology, and unless otherwise stated, it may be mentioned that the communication between the control unit 120 and the other elements of the exhaust gas recirculation circuit 10 and the internal combustion engine 11 is realized through sensor signals and actuator commands. The transmission of signals and commands to and from the control unit 120 is performed by known communication means, such as wired connection, wireless connection, local area network bus, serial peripheral interface bus, etc. For these purposes, the control unit 120 may comprise at least one processor. Under the term processor, it should be understood at least one of a processor, microprocessor, Application Specific Integrated Circuit (also known under its acronym ASIC), electronic circuit, central processing unit. The control unit 120 may comprise at least one memory component (read only, programmable read only, random access, hard drive, etc.) able to store machine readable instructions accessible by the processor to provide the desired functionality.

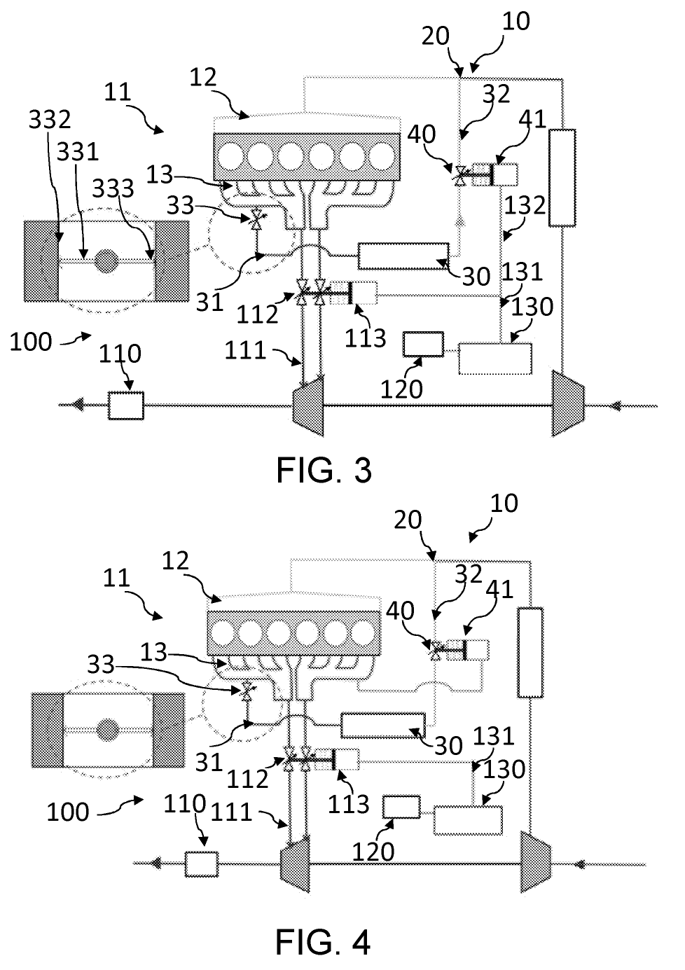

FIG. 3 is a schematic diagram showing an exemplary exhaust gas recirculation circuit 10 according to an example. The exhaust gas recirculation circuit 10 represented in FIG. 3 is identical to the exhaust gas recirculation circuit represented in FIG. 2.

The exhaust gas recirculation circuit 10 represented in FIG. 3 further comprises a second EGR valve 40 mounted in the intermediate pipe 32. The second EGR valve 40 is therefore disposed downstream of the EGR cooler 30. The second EGR valve 40 is configured to switch from an open position to a shut-off position to prevent exhaust gas flow from the exhaust manifold 13 to the EGR mixer 20 in the closed configuration, and vice versa. It means that the second EGR valve 40 is in an open position to allow exhaust gas to flow through the exhaust gas recirculation circuit 10 as discussed before. And in situations where it is desirable to have no exhaust gas flowing through the exhaust gas recirculation circuit 10, the second EGR valve 40 is in a fully closed position (shut-off position) to prevent exhaust gas through the exhaust gas recirculation circuit 10. Inversely, when the second EGR valve 40 is in its shut-off position, it may change its configuration and switch back to its open position depending on the requirement of the internal combustion engine.

On the left hand side of FIG. 3, a cut-view of the exhaust pipe 31 is depicted. Inside the exhaust pipe 31, the first EGR valve 33 is represented. The first EGR valve 33 is a butterfly valve and it is represented in its closed configuration. The first EGR valve 33 comprises a valve plate 331 that rotates within the valve housing 332. As can be seen, in the fully closed configuration, there are spacings between the valve plate 331 and the valve housing 332. This clearance is compulsory to avoid the sticking between the valve plate and the housing as the exhaust gas temperature is at a high level (about 700°C) at the outlet of the exhaust manifold. These spacings, even of a small dimension, form a passageway for the exhaust gas. It means that, even in a fully closed configuration of the first EGR valve 33, some exhaust gas may flow through the exhaust gas recirculation circuit 10.

As mentioned earlier, there are situations during the operating of the internal combustion engine where no exhaust gas recirculation should occur. One of these situations is the regeneration of the particle filter. During the step of regenerating the particle filter, soot particles that were caught by the filter are burnt. The conditions for operating a successful particle filter regeneration is a high exhaust gas temperature, a high exhaust gas mass flow rate and NOx emissions simultaneously in the exhaust line. Non-limitative examples of required values for a truck operating a parked regeneration at idle are an exhaust gas temperature above 250 °C, an exhaust gas mass flow rate above 0,07 kg/s and a NOx concentration in the exhaust gas of at least 1000 ppm. Depending on the speed and load of the vehicle, other thresholds may apply.

During the step of soot regeneration, the exhaust manifold pressure is controlled closed loop by the control unit 120 acting on the compressed air unit 130 and the actuator 113 for actuating the throttle 112, in order to achieve the target pressure in the exhaust manifold. When the exhaust manifold pressure is at the target pressure, the consequence of the passageway formed in the first EGR valve 33 is a high leakage flow in the exhaust gas recirculation circuit 10 (whereas it is expected that no exhaust gas flows through it) and the NOx level in the exhaust manifold drops below the required threshold. As a consequence, performing the particle filter regeneration becomes difficult or even impossible under such circumstances.

Thanks to the second EGR valve 40, the exhaust gas leakage flow is reduced. When a step of particle filter regeneration is triggered, the control unit sends a command both to the first EGR valve 33 and the second EGR valve 40 to make them switch into their fully closed position. As explained above, even in its fully closed position, a small flow rate of exhaust gas may circulate through the first EGR valve 33. By adding the second EGR valve 40 that is switched in its shut-off position, the exhaust gas leak flow is decreased in the exhaust gas recirculation circuit 10. Therefore, the second EGR valve 40 prevents exhaust gas flow from the exhaust manifold 13 to the EGR mixer 20 in the closed configuration of the circuit 10 (that is to say when the second EGR valve 40 is closed). As the exhaust gas leak flow is reduced to an acceptable level, it results in an increase of the NOx emissions in the exhaust gas in the exhaust manifold, until the required NOx level is reached, thereby facilitating particle filter regeneration.

The second EGR valve 40 may be a single butterfly valve, or it can be a single poppet valve. As mentioned before, the single poppet valve has the advantage of being fully tight when closed but at the cost of increased pressure drop, with increased pumping losses and fuel consumption penalty as a consequence.

Optionally in some examples, including in at least one preferred example, the second EGR valve 40 is a single butterfly valve. As the second EGR valve 40 is mounted in the intermediate pipe 32, that is to say downstream of the EGR cooler 30, the exhaust gas temperature to which the second EGR valve 40 is exposed is in the order of 150 °C. This allows smaller clearance (distance between the valve plate and the valve housing) compared to the first EGR valve 33 as the risk of valve sticking is reduced. It leads to reduced internal leakage through the second EGR valve 40.

Optionally in some examples, including in at least one preferred example, the second EGR valve 40 may comprise a sealing device such as an O-ring incorporated into the second EGR valve, thereby significantly reducing the internal leakage.

Thanks to the second EGR valve 40, the required flow rate of exhaust gas flows is maintained through the exhaust gas recirculation circuit 10 in the flowing configuration (the second EGR valve 40 is in its open position), and that little or no exhaust gas flow rate goes through the exhaust gas recirculation circuit 10 in the closed configuration.

Optionally in some examples, including in at least one preferred example, the exhaust gas recirculation circuit 10 comprises an actuator 41 connected to the second EGR valve 40. The actuator 41 is configured to actuate the second EGR valve 40 into its shut-off position when the exhaust gas recirculation circuit 10 evolves from the flowing configuration to the closed configuration. The control unit 120 is operatively connected to the actuator 41 and configured to send directly or indirectly, a command to the actuator 41 when it is required to switch the exhaust gas recirculation circuit 10 to the closed configuration.

As represented in FIG. 3, the actuator 41 is a pneumatic actuator. In this case, the control unit 120 sends a command to the compressed air unit 130 to provide compressed air to the actuator 41, to activate the second EGR valve 40. For that purpose, the internal combustion engine 11 comprises an auxiliary air supply pipe 132 fluidically connecting the main air supply pipe 131 to the pneumatic actuator 41. Advantageously, the pneumatic actuator 41 and the throttle actuator 113 are configured to be simultaneously supplied with compressed air.

FIG. 4 is a schematic diagram showing an exemplary exhaust gas recirculation circuit 10 according to an example. The exhaust gas recirculation circuit 10 represented in FIG. 4 is identical to the exhaust gas recirculation circuit represented in FIG. 3. The only difference between both exhaust gas recirculation circuit is the fluidic connection of the pneumatic actuator 41. Whereas the pneumatic actuator 41 is fluidically connected to the compressed air unit 130 in the circuit of FIG. 3, as a variant in FIG. 4, the pneumatic actuator 41 is connected to the exhaust manifold 13.

It results that the second EGR valve 40 is directly controlled by the exhaust manifold pressure. This leads to a simplification of the piping as this configuration only requires one pipe extending from the exhaust manifold 13 to the second EGR valve 40. The control of the second EGR valve 40 is also simplified as the second EGR valve 40 may switch between its open position to its shut-off position based on the pressure level in the exhaust manifold. Additionally, the fluidic connection between the exhaust manifold and the second EGR valve 40 has the advantage that the compressed air unit 130 can be removed in case that the throttle actuator 113 is an electric actuator.

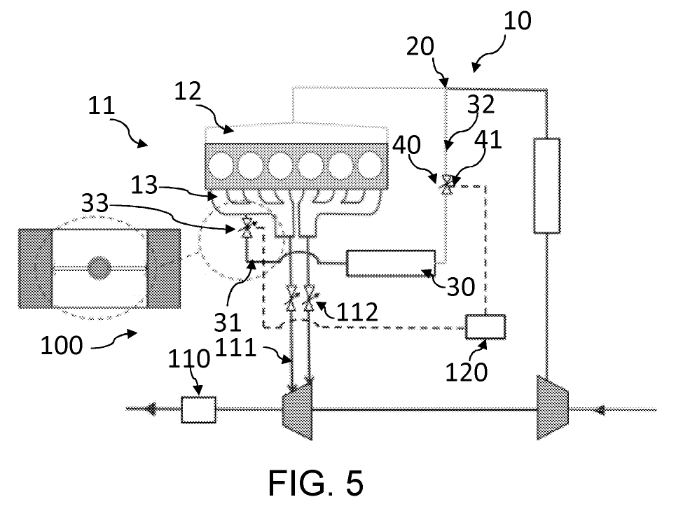

FIG. 5 is a schematic diagram showing an exemplary exhaust gas recirculation circuit 10 according to an example. The exhaust gas recirculation circuit 10 represented in FIG. 5 is almost identical to the exhaust gas recirculation circuit represented in FIG. 4. The only difference is that the first EGR valve 33 and the second EGR valve 40 are each coupled with an electric actuator that is controlled by the control unit 120. Considering that the throttle 112 may be equipped with an electric actuator also, the compressed air unit 130 is no more required.

Example 1: An exhaust gas recirculation circuit 10 of an internal combustion engine 11 comprising an inlet manifold 12 and an exhaust manifold 13 for collecting exhaust gas from the combustion in the internal combustion engine 11, said exhaust gas recirculation circuit 10 being configured to evolve between a flowing configuration, in which exhaust gas is allowed to flow through it, and a closed configuration, in which the exhaust gas flow through it is prevented, and vice versa, said exhaust gas recirculation circuit 10 comprising:

An EGR mixer 20 intended to be fluidically connected to the inlet manifold 12, and configured to be supplied with exhaust gas and air, and to mix them,

An EGR cooler 30, intended to be supplied with exhaust gas at an exhaust temperature Tex from the exhaust manifold 13 and to deliver exhaust gas at a target inlet temperature Tin,

An exhaust pipe 31 intended to fluidically connect the exhaust manifold 13 to the EGR cooler 30,

An intermediate pipe 32 fluidically connecting the EGR cooler 30 to the EGR mixer 20,

A first EGR valve 33 configured to adjust the exhaust gas flow rate flowing from the exhaust manifold 13 to the EGR mixer 20 in the flowing configuration and to prevent the exhaust gas flow to the EGR mixer 20 in the closed configuration, said first EGR valve 33 being mounted in the exhaust pipe 31.

Example 2: The exhaust gas recirculation circuit 10 of example 1, further comprising a second EGR valve 40 mounted in the intermediate pipe 32, said second EGR valve 40 being configured to switch from an open position to a shut-off position to prevent exhaust gas flow from the exhaust manifold 13 to the EGR mixer 20 in the closed configuration.

Example 3: The exhaust gas recirculation circuit 10 of example 1 or 2, wherein the first EGR valve 33 is a butterfly valve.

Example 4: The exhaust gas recirculation circuit 10 of example 2, further comprising an actuator 41 connected to the second EGR valve 40, said actuator 41 being configured to actuate the second EGR valve 40 into its shut-off position when the exhaust gas recirculation circuit 10 evolves from the flowing configuration to the closed configuration.

Example 5: The exhaust gas recirculation circuit 10 of example 4, wherein the actuator 41 is a pneumatic actuator.

Example 6: The exhaust gas recirculation circuit 10 of example 4, wherein the actuator 41 is an electric actuator.

Example 7: An internal combustion engine 11 comprising an inlet manifold 12, an exhaust manifold 13 for collecting exhaust gas from the combustion in the internal combustion engine 11, and an exhaust system 100 comprising:

an exhaust gas recirculation circuit 10 of any one of example 1 to 6,

an exhaust aftertreatment system 110 intended to process pollutants contained in the exhaust gas,

an exhaust line 111 fluidically connecting the exhaust manifold 13 to the exhaust aftertreatment system 110,

a control unit 120 configured to send a switching signal to the exhaust gas recirculation circuit 10 to evolve from the flowing configuration to the closed configuration, and vice versa.

Example 8: The internal combustion engine 11 of example 7, further comprising a throttle 112 mounted in the exhaust line 111 and a throttle actuator 113 connected to the throttle 112 and configured to actuate the throttle 112, so as to maintain a target value of the pressure inside the exhaust manifold 13.

Example 9: The internal combustion engine 11 of example 8, wherein the throttle actuator 113 is an electric actuator.

Example 10: The internal combustion engine 11 of example 8, further comprising a compressed air unit 130 and a main air supply pipe 131 fluidically connecting the compressed air unit 130 to the throttle actuator 113, said throttle actuator 113 being a pneumatically driven actuator, said compressed air unit 130 being configured to provide compressed air to the throttle actuator 113.

Example 11: The internal combustion engine 11 of example 10 in combination with example 5, further comprising an auxiliary air supply pipe 132 fluidically connecting the main air supply pipe 131 to the pneumatic actuator 41, said pneumatic actuator 41 and the throttle actuator 113 being configured to be simultaneously supplied with compressed air.

Example 12: The internal combustion engine 11 of any one of example 7 to 9 in combination with example 5, wherein the pneumatic actuator 41 is connected to the exhaust manifold 13.

Example 13: A vehicle comprising an internal combustion engine 11 of any one of examples 7 to 12.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. An internal combustion engine comprising an inlet manifold, an exhaust manifold for collecting exhaust gas from the combustion in the internal combustion engine, and an exhaust system comprising:
an exhaust gas recirculation circuit configured to evolve between a flowing configuration, in which exhaust gas is allowed to flow through it, and a closed configuration, in which the exhaust gas flow through it is prevented, and vice versa, the exhaust gas recirculation circuit comprising:
an EGR mixer intended to be fluidically connected to the inlet manifold, and configured to be supplied with exhaust gas and air, and to mix them;
an EGR cooler, intended to be supplied with exhaust gas at an exhaust temperature (Tex) from the exhaust manifold and to deliver exhaust gas at a target inlet temperature (Tin);
an exhaust pipe intended to fluidically connect the exhaust manifold to the EGR cooler;
an intermediate pipe fluidically connecting the EGR cooler to the EGR mixer;
a first EGR valve configured to adjust the exhaust gas flow rate flowing from the exhaust manifold to the EGR mixer in the flowing configuration and to prevent the exhaust gas flow to the EGR mixer in the closed configuration, the first EGR valve being mounted in the exhaust pipe;
a second EGR valve mounted in the intermediate pipe, the second EGR valve being configured to switch from an open position to a shut-off position to prevent exhaust gas flow from the exhaust manifold to the EGR mixer in the closed configuration;
an actuator connected to the second EGR valve, the actuator being configured to actuate the second EGR valve into its shut-off position when the exhaust gas recirculation circuit evolves from the flowing configuration to the closed configuration, the actuator being a pneumatic actuator;
an exhaust aftertreatment system intended to process pollutants contained in the exhaust gas;
an exhaust line fluidically connecting the exhaust manifold to the exhaust aftertreatment system; and
a control unit configured to send a switching signal to the exhaust gas recirculation circuit to evolve from the flowing configuration to the closed configuration, and vice versa,
wherein the pneumatic actuator is connected to the exhaust manifold.

2. The internal combustion engine of claim 1, wherein the first EGR valve is a butterfly valve.

3. The internal combustion engine of claim 1, further comprising a throttle mounted in the exhaust line and a throttle actuator connected to the throttle and configured to actuate the throttle, so as to maintain a target value of the pressure inside the exhaust manifold.

4. The internal combustion engine of claim 3, wherein the throttle actuator is an electric actuator.

5. The internal combustion engine of claim 3, further comprising a compressed air unit and a main air supply pipe fluidically connecting the compressed air unit to the throttle actuator, the throttle actuator being a pneumatically driven actuator, the compressed air unit being configured to provide compressed air to the throttle actuator.

6. A vehicle comprising an internal combustion engine according to claim 1.
